(19) United States
(12) Patent Application Publication
(10) Pub. No.: US 2023/0299358 A1
(43) Pub. Date: Sep. 21, 2023

(54) ALKALI METAL ION CONDUCTOR AND SECONDARY BATTERY

(71) Applicant: TOYOTA JIDOSHA KABUSHIKI KAISHA, Toyota-shi (JP)

(72) Inventor: Keiichi Minami, Tagata-gun (JP)

(21) Appl. No.: 18/183,197

(22) Filed: Mar. 14, 2023

(30) Foreign Application Priority Data
Mar. 18, 2022 (JP) 2022-044665

(51) Int. Cl. H01M 10/0568; H01M 4/60

(52) U.S. Cl. CPC H01M 10/0568; H01M 4/60

(57) ABSTRACT

Disclosed is an alkali metal ion conductor capable of improving filling ratio and ionic conductivity. The alkali metal ion conductor of the present disclosure comprises an alkali metal salt, wherein said alkali metal salt comprises a quaternary ammonium cation, an alkali metal ion, a first sulfonylamide anion, and a second sulfonylamide anion different from said first sulfonylamide anion.

### FIELD

The present application discloses an alkali metal ion conductor and a secondary battery.

### BACKGROUND

In Patent Document 1, a molten salt of LiFTA and CsFTA/KFTA is disclosed as a lithium-ion conductor for intermediate temperature operation.

### CITATION LIST

### Patent Documents

[Patent Document 1] JP 2013-084548 A

### SUMMARY

### Technical Problem

As for the conventional alkali metal ion conductor, the gap is likely to occur when it is filled and the filling ratio is likely to be small. In this regard, there is a need for a technique capable of improving the filling ratio when an alkali metal ion conductor is filled. Further, it is preferable not only to improve the filling ratio at the time of filling but also to improve the ion conductivity. In the conventional alkali metal ion conductor, there is room for improvement in terms of filling ratio and ion conductivity.

### Solution to Problem

As one means for solving the above problems, the present application discloses:
an alkali metal ion conductor, comprising an alkali metal salt,
wherein the alkali metal salt comprises a quaternary ammonium cation, an alkali metal ion, a first sulfonylamide anion, and a second sulfonylamide anion different from the first sulfonylamide anion.

In the alkali metal ion conductor of the present disclosure,
the first sulfonylamide anion may be a bistrifluoromethanesulfonylamide anion (TFSA anion), and
the second sulfonylamide anion may be at least one of a fluorosulfonylamide anion (FSA anion) and a fluorosulfonyl (trifluoromethanesulfonyl) amide anion (FTA anion).

In the alkali metal ion conductor of the present disclosure, a molar ratio of the first sulfonylamide anion to the second sulfonylamide anion (the first sulfonylamide anion/the second sulfonylamide anion) may be 1 or more.

The alkali metal ion conductor of the present disclosure may include the alkali metal salt and a sulfide solid electrolyte, wherein
the first sulfonylamide anion may be a bistrifluoromethanesulfonylamide anion (TFSA anion),
the second sulfonylamide anion may be at least one of a fluorosulfonylamide anion (FSA anion), and a fluorosulfonyl (trifluoromethanesulfonyl) amide anion (FTA anion), and
the molar ratio of the first sulfonylamide anion to the second sulfonylamide anion (the first sulfonylamide anion/the second sulfonylamide anion) may be 4 or more.

In the alkali metal ion conductor of the present disclosure, the quaternary ammonium cation may have a methyl group.

In the alkali metal ion conductor of the present disclosure, the alkali metal ion may be a lithium ion.

As one means for solving the above problems, the present application discloses:
a secondary battery comprising a positive electrode, an electrolyte layer and a negative electrode,
wherein at least one of the positive electrode, the electrolyte layer and the negative electrode comprises an alkali metal ion conductor of the present disclosure.

### Effects of Invention

According to the alkali metal ion conductor of the present disclosure, it is easy to improve the filling ratio and the ion conductivity. When a secondary battery is constructed using the alkali metal ion conductor of the present disclosure, battery performance tends to be enhanced.

### BRIEF DESCRIPTION OF DRAWINGS

FIG. 1 schematically shows the configuration of the secondary battery.

### DESCRIPTION OF EMBODIMENTS

### 1. Alkali Metal Ion Conductor

An alkali metal ion conductor of the present disclosure comprises an alkali metal salt. The alkali metal salt comprises a quaternary ammonium cation, an alkali metal ion, a first sulfonylamide anion, and a second sulfonylamide anion different from the first sulfonylamide anion.

### 1.1 Alkali Metal Salt

The alkali metal salt may be any one containing the above cations and anions, and the form thereof is not particularly limited. For example, the alkali metal salt may be a molten salt comprising the above cations and anions. The molten salt refers to a material obtained by mixing a plurality of salts and melting them together to be integrated.

When the alkali metal salt contains a plurality of kinds of cations and anions (the alkali metal salt is composed of a plurality of salts), the melting point of the alkali metal salt is lowered. Further, when the alkali metal salt contains a plurality of kinds of sulfonylamide anions, the alkali metal ion is easily dissociated. Thus, the alkali metal ion conductivity can be improved by the effect of lowering the melting point and the effect of improving the dissociability of the alkali metal ion. In the alkali metal ion conductor of the present disclosure, for example, an alkali metal salt containing cations and anions described above is employed in a solid state at room temperature, so that the alkali metal ion conductivity can be improved.

### 1.1.1 Cation

In the alkali metal ion conductor of the present disclosure, the alkali metal salt includes a quaternary ammonium cation and an alkali metal ion.

### (Quaternary Ammonium Cation)

When the alkali metal salt contains a quaternary ammonium cation, the Young's modulus of the alkali metal salt becomes small. When the Young's modulus of the alkali metal salt is small, the alkali metal salt can be deformed to fill the gap when the alkali metal ion conductor of the present disclosure is filled, and as a result, the filling ratio tends to increase. In addition, an alkali metal salt filled with a gap may function as an ion conduction path. This effect can be exerted both when the alkali metal ion conductor is mixed alone and when the alkali metal ion conductor is mixed with other solid materials.

According to the findings of the present inventor, the quaternary ammonium cation constituting the alkali metal salt has low reactivity with a sulfide solid electrolyte described later regardless of the type thereof. In addition, it is possible to reduce the Young's modulus of an alkali metal salt regardless of the type of an organic cation such as a quaternary ammonium cation. Therefore, in the alkali metal ion conductor of the present disclosure, there is no particular limitation on the type of the quaternary ammonium cation constituting the alkali metal salt. Examples of the quaternary ammonium cation include a cation having a functional group having 1 or more and 10 or less carbon atoms. Specific examples thereof include tetrabutylammonium cation (TBA cation), tetrapropylammonium cation (TPA cation), tetraethylammonium cation (TEA cation), tetramethylammonium cation (TMA cation), tetraamylammonium (TAA), tetrahexylammonium (THA), tetraoctylammonium (TOA), and tetradecylammonium (TDA). The quaternary ammonium cation may be one having functional groups having a different number of carbon atoms from each other. For example, it may have a first functional group having 1 or more and 10 or less carbon atoms and a second functional group having 1 or more and 10 or less carbon atoms and different from the first functional group. Such cations include, for example, trimethylpropylammonium cations and the like. As long as the present inventor has confirmed, when the quaternary ammonium cation is one having a methyl group, for example, when it is a TMA cation, an alkali-metal ion conductor having more excellent ion conductivity or the like is easily obtained. In addition, when the quaternary ammonium cation is one having a butyl group, for example, when it is a TBA cation, ionic conductivity can be also secured. The alkali metal salt may be one containing only one kind of quaternary ammonium cations, or may be one containing two or more kinds.

### (Alkali Metal Ion)

The alkali metal ion may be determined depending on the type of carrier ion to be conducted. When the alkali metal ion conductor of the present disclosure is one used in a lithium ion secondary battery, the alkali metal ion may be a lithium ion. In other words, since the alkali metal salt contains the same kind of cation as the carrier ion in the secondary battery, the performance of the secondary battery is more easily enhanced. The alkali metal salt may contain only one kind of alkali metal ions, or may contain two or more kinds thereof.

### (Other Cations)

The cations constituting the alkali metal salt may be composed only of the above-mentioned quaternary ammonium cation and alkali metal ion, or may contain other cations within a range in which a desired effect is exhibited. From the viewpoint that the effect by the alkali metal ion conductor of the present disclosure is further enhanced, the total ratio of the above-mentioned quaternary ammonium cation and alkali metal ion to the entire cation constituting the alkali metal salt may be 80 mol % or more, 90 mol % or more, 95 mol % or more, 99 mol % or more or 100 mol %.

### (Molar Ratio for Cations)

The molar ratio of the quaternary ammonium cation to the alkali metal ion constituting the alkali metal salt is not particularly limited. When the alkali metal salt contains a quaternary ammonium cation and an alkali metal ion, the melting point of the alkali metal salt decreases as compared with a case where each of them is contained alone. From the viewpoint of greatly lowering the melting point of the alkali metal salt, the molar ratio of the quaternary ammonium cation to the alkali metal ion (the quaternary ammonium cation/the alkali metal ion) may be 0.3 or more and 2.5 or less. The Moll ratio may be 0.4 or more, 0.5 or more or 0.6 or more, and may be 2.2 or less, 2.0 or less, 1.8 or less or 1.5 or less.

### 1.1.2 Anion

In the alkali metal ion conductor of the present disclosure, the alkali metal salt comprises a first sulfonylamide anion and a second sulfonylamide anion. The first sulfonylamide anion and the second sulfonylamide anion are of different kinds from each other. It is considered that the inclusion of a plurality of kinds of sulfonylamide anions in an alkali metal salt lowers the melting point of an alkali metal salt and also increases the dissociability of an alkali metal ion. Therefore, an alkali metal salt containing a plurality of kinds of sulfonylamide anions tends to be improved in ion conductivity at a low temperature (e.g., at room temperature) and in a solid state as compared with an alkali metal salt containing only one kind of sulfonylamide anion alone. Thus, the effect of combining a plurality of types of sulfonylamide anions can be exerted regardless of the type of sulfonylamide anion to be combined.

### (Sulfonylamide Anion)

Examples of the sulfonylamide anion include a trifluoromethanesulfonylamide anion (TFSA anion, (CF₃SO₂)₂N⁻), a fluorosulfonylamide anion (FSA anion, (FSO₂)₂N⁻), a fluorosulfonyl (trifluoromethanesulfonyl) amide anion (FTA anion, FSO₂(CF₃SO₂)N⁻), and the like, which may be optionally combined and adopted as the first sulfonylamide anion and the second sulfonylamide anion.

In the alkali metal ion conductor of the present disclosure, for example, the first sulfonylamide anion described above may be a TFSA anion, and the second sulfonylamide anion described above may be at least one of a FSA anion and a FTA anion. According to the findings of the present inventor, the reactivity of an alkali metal salt to a sulfide solid electrolyte to be described later varies depending on the type of anion constituting an alkali metal salt. For example, the FTA anion and FSA anion are highly polar and easily react with sulfide solid electrolytes. In contrast, the TFSA anion is less polar and hardly react with sulfide solid electrolytes. As described above, when TFSA anion and the sulfonylamide anion other than TFSA anion are combined, the reactivity with the sulfide solid electrolyte can be reduced more than when TFSA anion is not contained.

### (Other Anions)

The anions constituting the alkali metal salt may be composed only of the above-mentioned first sulfonylamide anion and the second sulfonylamide anion, or may contain other anions within a range in which a desired effect is exhibited. From the viewpoint of further enhancing the effect by the alkali metal ion conductor of the present disclosure, the total ratio of the sulfonylamide anion in the entire anion constituting the alkali metal salt may be 80 mol % or more, 90 mol % or more, 95 mol % or more, 99 mol % or more, or 100 mol %

### (Molar Ratio for Anions)

The molar ratio of the first sulfonylamide anion to the second sulfonylamide anion is not particularly limited. For example, when the first sulfonylamide anion is a TFSA anion and the second sulfonylamide anion is at least one of a FSA anion and a FTA anion, the molar ratio of the first sulfonylamide anion to the second sulfonylamide anion (the first sulfonylamide anion/the second sulfonylamide anion) may be 1 or more. The molar ratio may be 2 or more, 3 or more, or 4 or more, and may be 20 or less, 15 or less, 10 or less, 9 or less, 8 or less, or 7 or less. As described above, when the molar amount of TFSA anion as the first sulfonylamide anion is equal to or higher than the molar amount of FSA anion and FTA anion as the second sulfonylamide anion (when both of FSA anion and FTA anion are included, the molar amount of the sum thereof) the reactivity with the sulfide solid electrolyte to be described later can be further reduced. In particular, when the molar ratio (first sulfonylamide anion/second sulfonylamide anion) is 4 or more, reactivity with the sulfide solid electrolyte is particularly easily suppressed.

### 1.2 Sulfide Solid Electrolyte

The alkali metal ion conductor of the present disclosure may contain other components together with the alkali metal salt described above. For example, the alkali metal ion conductor of the present disclosure may include an alkali metal salt and a sulfide solid electrolyte described above. In this case, as described above, the first sulfonylamide anion in the alkali metal salt may be a TFSA anion, the second sulfonylamide anion may be at least one of a FSA anion, and a FTA anion, and the molar ratio of the first sulfonylamide anion to the second sulfonylamide anion (the first sulfonylamide anion/the second sulfonylamide anion) may be more than 1 or more, 2 or more, 3 or more, or 4 or more. The molar ratio may be 20 or less, 15 or less, 10 or less, 9 or less, 8 or less, or 7 or less.

As the sulfide solid electrolyte, for example, any one used as a solid electrolyte of a secondary battery can be adopted. The sulfide solid electrolyte may contain at least an alkali metal and S as constituent elements. The alkali metal may be determined depending on the type of carrier ion to be conducted. When the alkali metal ion conductor of the present disclosure is one applied to a lithium ion secondary battery, the sulfide solid electrolyte may contain lithium as an alkali metal. In particular, the sulfide solid electrolyte containing at least Li, S and P as a constituent element has high performance, and the sulfide solid electrolyte based on Li₃PS₄ skeleton and containing at least one or more kinds of halogens also has high performance. An exemplary solid-state electrolyte may include Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, Li₂S—P₂S₅—GeS₂ or the like. The sulfide solid electrolyte may be an amorphous or a crystal. The sulfide solid electrolyte may be, for example, particulate. Only one kind of sulfide solid electrolyte may be used alone, or two or more kinds thereof may be used in combination.

When the alkali metal ion conductor of the present disclosure includes a sulfide solid electrolyte together with an alkali metal salt, the mass ratio of the sulfide solid electrolyte to the alkali metal salt is not particularly limited. For example, the sum of the sulfide solid electrolyte and the alkali metal salt as 100 mass %, sulfide solid electrolyte ratio may be 40 mass % or more and less than 100 mass %, 50 mass % or more and less than 100 mass %, 60 mass % or more and less than 100 mass %, 70 mass % or more and less than 100 mass %, or 80 mass % or more and less than 100 mass %, and the alkali metal salt ratio may be more than 0 mass % and 60 mass % or less, more than 0 mass % and 50 mass % or less, more than 0 mass % and 40 mass % or less, more than 0 and 30 mass % or less, or more than 0 mass % and 20 mass % or less.

### 1.3 Optional Ingredients

The alkali metal ion conductor of the present disclosure may be one in which the alkali metal salt described above, an optional sulfide solid electrolyte, and other components are combined. Other components may be appropriately determined depending on the specific application of the alkali metal ion conductor. For example, when an alkali metal ion conductor is used as an electrode material of a secondary battery, an active material, a conductive aid, a binder, and the like may be combined together with an alkali metal ion conductor. In addition, when an alkali metal ion conductor is used as a material constituting an electrolyte layer of a secondary battery, a binder or the like may be combined together with an alkali metal ion conductor. Note that the alkali metal ion conductor may include an alkali metal salt described above, an optional sulfide solid electrolyte, and other electrolytes (a solid electrolyte other than the sulfide solid electrolyte or a liquid electrolyte). Further, the alkali metal ion conductor of the present disclosure may contain various additives.

### 2. Secondary Battery

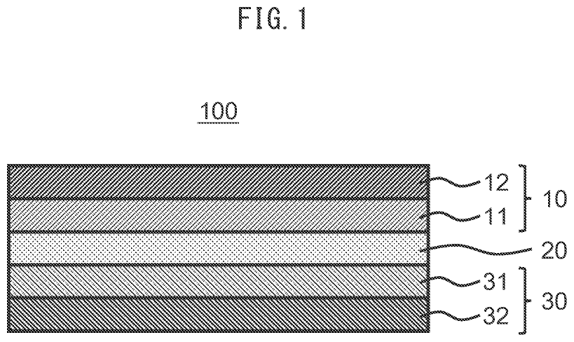

As shown in FIG. 1, a secondary battery 100 according to an embodiment includes a positive electrode 10, an electrolyte layer 20, and a negative electrode 30. Here, at least one of the positive electrode 10, the electrolyte layer 20, and the negative electrode 30 includes the alkali metal ion conductor of the present disclosure described above. As described above, since the alkali metal salt constituting the alkali metal ion conductor of the present disclosure contains a quaternary ammonium cation, the alkali metal ion conductor can be filled with a high filling ratio. Further, when the alkali metal salt contains a plurality of kinds of sulfonylamide anions, the ion conductivity of the alkali metal ion conductor is easily improved. In this regard, the alkali metal ion conductor of the present disclosure is included in at least one of the positive electrode 10, the electrolyte layer 20, and the negative electrode 30 of the secondary battery 100, so that the performance of the secondary battery 100 tends to be enhanced. Note that, although the alkali metal ion conductor of the present disclosure described above may be included as a solid electrolyte in the secondary battery 100, a liquid electrolyte or a liquid additive may be used together therewith. In other words, the secondary battery 100 may be an all-solid battery or may be the one including a solid electrolyte and liquid.

### 2.1 Positive Electrode

As shown in FIG. 1, the positive electrode 10 according to an embodiment may include a positive electrode active material layer 11 and a positive electrode current collector 12, and in this case, the positive electrode active material layer 11 may include the alkali metal ion conductor described above.

### 2.1.1 Positive Electrode Active Material Layer

The positive electrode active material layer 11 includes a positive electrode active material, and may further optionally include an electrolyte, a conductive aid, a binder, and the like. Further, the positive electrode active material layer 11 may contain various additives. When the positive electrode active material layer 11 includes the alkali metal ion conductor of the present disclosure as an electrolyte, the positive electrode active material layer 11 includes a positive electrode active material in addition to the alkali metal ion conductor, and may further optionally include other electrolytes, conductive aids, binders, and various additives. The content of each of the positive electrode active material, the electrolyte, the conductive aid, the binder, and the like in the positive electrode active material layer 11 may be appropriately determined according to the battery performance. For example, taking the entire positive electrode active material layer 11 (entire solid content) as 100 mass %, the content of the positive electrode active material may be 40 mass % or more, 50 mass % or more, or 60 mass % or more, and may be less than 100 mass % or 90 mass % or less. The shape of the positive electrode active material layer 11 is not particularly limited, and may be, for example, a sheet shape having a substantially planar surface. Thickness of the positive active material layer 11 is not particularly limited, and may be for example, 0.1 μm or more, 1 μm or more, 10 μm or more or 30 μm or more, and may be 2 mm or less, 1 mm or less, 500 μm or less or 100 μm or less.

Those known as the positive electrode active material of the secondary battery may be used as the positive electrode active material. Among known active materials, a material having a potential (charge/discharge potential) for occluding and releasing a predetermined ion and exhibiting a more noble potential than that of a negative electrode active material described later can be used as a positive electrode active material. For example, when constituting a lithium ion secondary battery, various lithium-containing composite oxides such as lithium cobaltate, lithium nickelate, lithium manganate, lithium manganese nickel cobaltate, and a spinel-based lithium compound may be used as the positive electrode active material, or a sulfur-based active material such as a single substance sulfur or a sulfur compound may be used. Only one kind of positive electrode active material may be used alone, or two or more kinds thereof may be used in combination. The positive electrode active material may be, for example, particulate, and the size thereof is not particularly limited. The particles of the positive electrode active material may be solid particles, and may be hollow particles, and may be particles having voids. The particles of the positive electrode active material may be primary particles or secondary particles in which a plurality of primary particles are aggregated. The mean particle diameter of the particles of the positive active material may be 1 nm or more, 5 nm or more, or 10 nm or more, and may be 500 μm or less, 100 μm or less, 50 μm or less, or 30 μm or less.

The surface of the positive electrode active material may be coated with a protective layer containing an ion conductive oxide. In other words, the positive electrode active material layer 11 may include a composite comprising the above-described positive electrode active material and a protective layer provided on the surface thereof. Thus, a reaction between the positive electrode active material and sulfide (e.g., the above-described sulfide solid electrolyte or the like) is easily suppressed. When the secondary battery is a lithium-ion secondary battery, an ion conductive oxide that covers and protects the surface of the positive active material includes, for example, Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, Li₂WO₄. The coverage ratio (area ratio) of the protective layer may be, for example, 70% or more, 80% or more, or 90% or more. The thickness of the protective layer may be, for example, 0.1 nm or more or 1 nm or more, and may be 100 nm or less or 20 nm or less.

The electrolyte that may be contained in the positive electrode active material layer 11 may be a solid electrolyte, a liquid electrolyte (electrolytic solution), or a combination thereof.

The solid electrolyte may be the alkali metal ion conductor of the present disclosure described above, or may be a solid electrolyte other than this. As for the solid electrolyte other than the alkali metal ion conductor of the present disclosure described above, the one well known as a solid electrolyte of a secondary battery may be used. The solid electrolyte may be an inorganic solid electrolyte or an organic polymer electrolyte. In particular, the inorganic solid electrolyte is excellent in ionic conductivity and heat resistance. As the inorganic solid electrolyte, for example, an oxide solid electrolyte such as lithium lanthanum zirconate, LiPON, Li_{1+X}Al_{X}Ge_{2-X}(PO₄)₃, Li—SiO based glass, or Li—Al—S—O based glass can be exemplified in addition to the sulfide solid electrolyte described above. In particular among them, a sulfide solid electrolyte, more particular, a sulfide solid electrolyte containing at least Li, S and P as constituent elements has high performance. The solid electrolyte may be amorphous or crystalline. The solid electrolyte may be, for example, particulate. Only one kind of solid electrolyte may be used alone, or two or more kinds thereof may be used in combination.

The electrolytic solution may comprise, for example, an alkali metal ion as a carrier ion. The electrolytic solution may be, for example, a non-aqueous electrolytic solution. For example, as an electrolytic solution, a solution obtained by dissolving an alkali metal salt in a carbonate-based solvent at a predetermined concentration can be used. Examples of the carbonate-based solvents include fluoroethylene carbonate (FEC), ethylene carbonate (EC), and dimethyl carbonate (DMC). Examples of the alkali metal salt include hexafluorophosphate and the like.

Examples of the conductive aid which may be contained in the positive electrode active material layer 11 include carbon materials such as vapor-grown carbon fibers (VGCF), acetylene black (AB), Ketjen black (KB), carbon nanotubes (CNT), and carbon nanofibers (CNF); and metallic materials such as nickel, aluminum, and stainless steel. The conductive aid may be, for example, particulate or fibrous, and the size thereof is not particularly limited. Only one kind of the conductive aid may be used alone, or two or more kinds thereof may be used in combination.

Examples of the binder which may be contained in the positive electrode active material layer 11 include a butadiene rubber (BR) based binder, a butylene rubber (IIR) based binder, an acrylate butadiene rubber (ABR) based binder, a styrene butadiene rubber (SBR) based binder, a polyvinylidene fluoride (PVdF) based binder, a polytetrafluoroethylene (PTFE) based binder, a polyimide (PI) based binder, a polyacrylic acid-based binder, and the like. Only one kind of binder may be used alone, or two or more kinds thereof may be used in combination.

### 2.1.2 Cathode Current Collector

As shown in FIG. 1, the positive electrode 10 may include a positive electrode current collector 12 in contact with the positive electrode active material layer 11 described above. The positive electrode current collector 12 can adopt any of common ones as a positive electrode current collector of a battery. Further, the positive electrode current collector 12 may be a foil, a plate, a mesh, a punching metal, a foam, or the like. The positive electrode current collector 12 may be constituted by a metal foil or a metal mesh. In particular, a metal foil is excellent in handling property and the like. The positive electrode current collector 12 may be made of a plurality of foils. Exemplary metals constituting the positive current collector 12 include Cu, Ni, Cr, Au, Pt, Ag, Al, Fe, Ti, Zn, Co, stainless-steel, and the like. In particular, from the viewpoint of ensuring oxidation resistance and the like, the positive electrode current collector 12 may include Al. The positive electrode current collector 12 may have some coating layer on its surface for the purpose of adjusting the resistance or the like. Further, the positive electrode current collector 12 may be one in which the above metal is plated or deposited on a metal foil or a base material. In addition, when the positive electrode current collector 12 is made of a plurality of metal foils, some layer may be provided between the plurality of metal foils. The thickness of the positive electrode current collector 12 is not particularly limited. For example, it may be 0.1 μm or more or 1 μm or more, and may be 1 mm or less or 100 μm or less.

In addition to the above configuration, the positive electrode 10 may be provided with a general configuration as a positive electrode of a secondary battery. For example, a tab, a terminal, or the like. The positive electrode 10 can be manufactured by applying a known method. For example, the positive electrode active material layer 11 can be easily formed by molding a positive electrode mixture containing various components described above in a dry or wet manner or the like. The positive electrode active material layer 11 may be molded together with the positive electrode current collector 12, or may be molded separately from the positive electrode current collector 12

### 2.2 Electrolyte Layer

The electrolyte layer 20 includes at least an electrolyte. The electrolyte layer 20 may include a solid electrolyte, and may further optionally include a binder and etc. When the electrolyte layer 20 includes the alkali metal ion conductor of the present disclosure described above as an electrolyte, the electrolyte layer 20 may further include other electrolytes, binders, and various additives in addition to the alkali metal ion conductor. In this case, the content of the solid electrolyte, the binder, and the like in the electrolyte layer 20 is not particularly limited. Alternatively, the electrolyte layer 20 may include an electrolytic solution, and may further include a separator or the like for holding the electrolytic solution and preventing contact between the positive electrode active material layer 11 and the negative electrode active material layer 31. The thickness of the electrolyte layer 20 is not particularly limited, and may be, for example, 0.1 μm or more or 1 μm or more, and may be 2 mm or less or 1 mm or less.

The electrolyte contained in the electrolyte layer 20 may be appropriately selected from those exemplified as the alkali metal ion conductor of the present disclosure described above and the electrolyte which may be contained in the positive electrode active material layer described above. Further, the binder which may be included in the electrolyte layer 20 may be appropriately selected from those exemplified as the binder which may be included in the positive electrode active material layer described above. Only one kind of the electrolyte and the binder may be used alone, or two or more kinds thereof may be used in combination. When the secondary battery is an electrolytic solution battery, the separator for holding the electrolytic solution may be any separator commonly used in a secondary battery, and examples thereof include a separator made of a resin such as polyethylene (PE), polypropylene (PP), polyester, and polyamide. The separator may have a single layer structure or a multi-layer structure. Examples of the separator having a multi-layer structure include a separator having a two layer structure of PE/PP, or a separator having a three layer structure of PP/PE/PP or PE/PP/PE. The separator may be made of a nonwoven fabric such as a cellulose nonwoven fabric, a resin nonwoven fabric, or a glass fiber nonwoven fabric.

### 2.3 Negative Electrode

As shown in FIG. 1, the negative electrode 30 according to an embodiment may include a negative electrode active material layer 31 and a negative electrode current collector 32, and in this case, the negative electrode active material layer 31 may include the alkali metal ion conductor described above.

### 2.3.1 Negative Electrode Active Material Layer

The negative electrode active material layer 31 includes a negative electrode active material, and may further optionally include an electrolyte, a conductive aid, a binder, and the like. Further, the negative electrode active material layer 31 may contain various other additives. When the negative electrode active material layer 31 contains the alkali metal ion conductor of the present disclosure described above as an electrolyte, the negative electrode active material layer 31 includes a negative electrode active material in addition to the alkali metal ion conductor, and may further optionally include other electrolytes, conductive aids, binders, and various additives. The content of each of the negative electrode active material, the electrolyte, the conductive aid, the binder, and the like in the negative electrode active material layer 31 may be appropriately determined according to the battery performance. For example, the content of the negative electrode active material may be 40 mass % or more, 50 mass % or more, or 60 mass % or more, and may be less than 100 mass % or 90 mass % or less, taking the entire negative electrode active material layer 31 (entire solid content) as 100 mass %. The shape of the negative electrode active material layer 31 is not particularly limited, and may be, for example, a sheet shape having a substantially planar surface. The thickness of the negative active material layer 31 is not particularly limited. For example, it may be 0.1 μm or more, 1 μm or more, 10 μm or more, or 30 μm or more, and may be 2 mm or less, 1 mm or less, 500 μm or less, or 100 μm or less.

As the negative electrode active material, various materials in which a potential (charge/discharge potential) for occluding and releasing a predetermined ion is a base potential as compared with the positive electrode active material described above can be adopted. For example, a silicon-based active material such as Si, a Si alloy, or silicon oxide; a carbon-based active material such as graphite or hard carbon; various oxide-based active materials such as lithium titanate; metallic lithium, lithium alloy, or the like may be employed. Only one kind of negative electrode active material may be used alone, or two or more kinds thereof may be used in combination. The shape of the negative electrode active material may be any general shape as the negative electrode active material of the secondary battery. For example, the negative electrode active material may be particulate. The negative electrode active material particles may be primary particles or secondary particles in which a plurality of primary particles are aggregated. The mean particle diameter (D50) of the negative active material particles may be 1 nm or more, 5 nm or more, 10 nm or more, and may be 500 μm or less, 100 μm or less, 50 μm or less, or 30 μm or less. Alternatively, the negative electrode active material may be a sheet (foil or film) such as a lithium foil. In other words, the negative electrode active material layer 31 may be made of a sheet of negative electrode active material.

Examples of the electrolyte that may be included in the negative electrode active material layer 31 include the above-described alkali metal ion conductor of the present disclosure, the above-described solid electrolyte, an electrolytic solution, or a combination thereof. Examples of the conductive aid which may be included in the negative electrode active material layer 31 include the above-mentioned carbon material and the above-mentioned metal material. The binder which may be included in the negative electrode active material layer 31 may be appropriately selected from those exemplified as the binder which may be included in the positive electrode active material layer 11 described above, for example. Only one kind of the electrolyte and the binder may be used alone, or two or more kinds thereof may be used in combination.

### 2.3.2 Anode Current Collector

As shown in FIG. 1, the negative electrode 30 may include a negative electrode current collector 32 in contact with the negative electrode active material layer 31 described above. The negative electrode current collector 32 can adopt any of common ones as a negative electrode current collector of a battery. Further, the negative electrode current collector 32 may be a foil, a plate, a mesh, a punching metal, a foam, or the like. The negative electrode current collector 32 may be a metal foil or a metal mesh, or may be a carbon sheet. In particular, a metal foil is excellent in handling property and the like. The negative electrode current collector 32 may be formed of a plurality of foils or sheets. Exemplary metals constituting the negative current collector 32 include Cu, Ni, Cr, Au, Pt, Ag, Al, Fe, Ti, Zn, Co, stainless-steel, and the like. In particular, from the viewpoint of ensuring reduction resistance and from the viewpoint of hardly alloying with an alkali metal, the negative electrode current collector 32 may be one containing at least one metal selected from Cu, Ni and stainless-steel. The negative electrode current collector 32 may have some coating layer on its surface for the purpose of adjusting the resistance or the like. Further, the negative electrode current collector 32 may be one in which the above metal is plated or deposited on a metal foil or a base material. In addition, when the negative electrode current collector 32 is made of a plurality of metal foils, some layer may be provided between the plurality of metal foils. The thickness of the negative electrode current collector 32 is not particularly limited. For example, it may be 0.1 μm or more or 1 μm or more, and may be 1 mm or less or 100 μm or less.

In addition to the above configuration, the negative electrode 30 may be provided with a general configuration as a negative electrode of a secondary battery. For example, a tab, a terminal, or the like. The negative electrode 30 can be manufactured by applying a known method. For example, the negative electrode active material layer 31 can be easily formed by molding a negative electrode mixture containing various components described above in a dry or wet manner or the like. The negative electrode active material layer 31 may be molded together with the negative electrode current collector 32, or may be molded separately from the negative electrode current collector 32

### 2.4 Other Components

The secondary battery 100 may be one in which each of the above-described configurations is housed inside an exterior body. Any of the exterior bodies known as an exterior body of a battery can be employed as the exterior body. Further, a plurality of secondary battery 100 is optionally electrically connected, also, optionally superimposed to obtain a battery assembly. In this case, the battery assembly may be housed inside a known battery case. Secondary battery 100 may be provided with an obvious configuration such as required terminals. The shape of the secondary battery 100 can include, for example, a coin, laminate, cylindrical, and rectangular cylindrical.

The secondary battery 100 can be manufactured by applying a known method. For example, it can be produced as follows. However, the method of manufacturing the secondary battery 100 is not limited to the following method, and each layer may be formed by, for example, dry molding or the like.

(1) A positive electrode active material or the like constituting the positive electrode active material layer is dispersed in a solvent to obtain a slurry for a positive electrode layer. The solvent used in this case is not particularly limited, and water or various organic solvents may be used, and may be N-methylpyrrolidone (NMP) A positive electrode active material layer is formed on the surface of a positive electrode current collector by coating a slurry for a positive electrode layer on a surface of a positive electrode current collector using a doctor blade or the like and then drying the slurry, thereby forming a positive electrode.

(2) A negative electrode active material or the like constituting the negative electrode active material layer is dispersed in a solvent to obtain a slurry for a negative electrode layer. The solvent used in this case is not particularly limited, and water or various organic solvents may be used, and may be N-methylpyrrolidone (NMP) Thereafter, a slurry for a negative electrode layer is coated on the surface of a negative electrode current collector using a doctor blade or the like, and then dried, whereby a negative electrode active material layer is formed on the surface of the negative electrode current collector, thereby forming a negative electrode.

(3) Each layer is laminated so as to sandwich an electrolyte layer (a solid electrolyte layer or a separator) between a negative electrode and a positive electrode, and a laminate having a negative electrode current collector, a negative electrode active material layer, an electrolyte layer, a positive electrode active material layer and a positive electrode current collector in this order is obtained. Other members such as terminals is attached to the laminate as necessary.

(4) The laminate is housed in a battery case, and in the case of an electrolytic solution battery, an electrolytic solution is filled in the battery case, and the laminate is immersed in the electrolytic solution, so that the laminate is sealed in the battery case, thereby forming a secondary battery. In the case of a battery containing an electrolytic solution, an electrolytic solution may be contained in the negative electrode active material layer, the separator, and the positive electrode active material layer at the stage (3) described above.

### EXAMPLES

As described above, although an embodiment of the alkali metal ion conductor and the secondary battery of the present disclosure has been described, the alkali metal ion conductor and the secondary battery of the present disclosure can be variously modified other than the above-described embodiment without departing from the gist thereof. Hereinafter, the technique of the present disclosure will be described in further detail with reference to Examples, but the technique of the present disclosure is not limited to the following Examples.

### 1. Preliminary Study

Sulfide solid-state electrolytes based on a Li₃PS₄ skeleton were compacted alone. The cross section of the molded body was observed under a SEM-EDX, and the void ratio of the molded body was calculated to be 27.1%. Since the Young's modulus of the sulfide solid electrolyte was high, in the compact form, the gap between the sulfide solid electrolytes could not be sufficiently filled.

Tetrabutylammonium bistrifluoromethanesulfonylamide (TB ATFS A) and lithium trifluoromethanesulfonylamide (LiTFSA) were mixed in a molar ratio of 50:50 and completely melted at 100° C. Thereafter, the crystals solidified at room temperature were pulverized to obtain an alkali metal salt (molten salt) containing TBA cation as quaternary ammonium cation, lithium ion as alkali metal ion, and TFSA anion. The sulfide solid electrolyte and the molten salt were mixed in a mass ratio of a sulfide solid electrolyte:molten salt=80:20 to obtain an electrolyte material for evaluation. The resulting electrolyte material was molded by compacting. The cross section of the molded body was observed under a SEM-EDX, and the void ratio of the molded body was calculated to be 19.8%.

As described above, it can be seen that an alkali-metal salt (molten salt) containing a quaternary ammonium cation such as a TBA cation has a small Young's modulus and is easy to increase the filling ratio at the time of forming/molding. There is no particular limitation on the proportion of the quaternary ammonium cation in the alkali metal salt, and as long as the alkali metal salt contains the quaternary ammonium cation, the Young's modulus of the alkali metal salt becomes small, and the above-described effect of improving the filling ratio can be obtained. On the other hand, when the molten salt does not contain a quaternary ammonium cation, the Young's modulus of the molten salt does not decrease, and the effect of improving the filling ratio becomes small.

### 2. Confirmation of Changes in Ionic Conductivity by Cationic and Anionic Species

Ion conductivity was confirmed while changing the types of cations and anions constituting the alkali metal salt. Incidentally, the alkali metal salt according to the following examples and comparative examples, both are those having a quaternary ammonium cation, has a small Young's modulus, it is easy to increase the filling ratio at the time of molding.

### 2.1 Fabrication of Alkali Metal Salts as Ionic Conductors

The alkali metal salts according to Examples 1 to 5 and Comparative Examples 1 and 2 were prepared by the following procedures.

### 2.1.1 Example 1

Tetramethylammonium bistrifluoromethanesulfonylamide (TMATFSA), LiTFSA, and lithium fluorosulfonylamide (LiFSA) were mixed in a molar ratio of 1:1:0.2, which was melted by heating at 100° C. Thereafter, the crystals solidified at room temperature were pulverized to obtain a powder composed of an alkali metal salt.

### 2.1.2 Example 2

A powder was obtained in the same manner as in Example 1, except that TMATFSA, LiTFSA, and LiFSA were mixed in a molar ratio at a ratio of 1:1:0.5

### 2.1.3 Example 3

A powder was obtained in the same manner as in Example 1, except that TMATFSA, LiTFSA, and fluorosulfonyl (trifluoromethanesulfonyl) amide (LiFTA) were mixed in a molar ratio of 1:1:0.5

### 2.1.4 Example 4

A powder was obtained in the same manner as in Example 1, except that tetrabutylammonium bistrifluoromethanesulfonylamide (TBATFSA), LiTFSA, and LiFSA were mixed in a molar ratio of 1:1:0.2

### 2.1.5 Example 5

A powder was obtained in the same manner as in Example 1, except that TBATFSA, LiTFSA, and LiFSA were mixed in a molar ratio of 1:1:0.5

### 2.1.6 Comparative Example 1

A powder was obtained in the same manner as in Example 1, except that TBATFSA and LiTFSA were mixed in a molar ratio of 1:1.

### 2.1.7 Comparative Example 2

A powder was obtained in the same manner as in Example 1, except that TMATFSA and LiTFSA were mixed in a molar ration of 1:1.

### 2.2 Calculation of Ionic Conductivity

The powder according to Examples 1 to 5 or Comparative Examples 1 and 2, respectively, was used in order to prepare a compact cell, and ionic conductivity in a solid state was calculated from impedance measurement at room temperature (25° C.). The results are shown in Table 1 below.

TABLE 1

| | | | Conductivity |
|---|---|---|---|
| | | | at room |
| | | Molar | temperature |
| | Composition of Salt | Ratio | (S/cm) |
| Ex. 1 | TMATFSA:LiTFSA:LiFSA | 1:1:0.2 | 4.7 × 10⁻⁷ |
| Ex. 2 | TMATFSA:LiTFSA:LiFSA | 1:1:0.5 | 2.3 × 10⁻⁶ |
| Ex. 3 | TMATFSA:LiTFSA:LiFTA | 1:1:0.5 | 1.1 × 10⁻⁸ |
| Ex. 4 | TBATFSA:LiTFSA:LiFSA | 1:1:0.2 | 8.5 × 10⁻⁹ |
| Ex. 5 | TBATFSA:LiTFSA:LiFSA | 1:1:0.5 | 2.0 × 10⁻⁹ |
| Comp. Ex. 1 | TMATFSA:LiTFSA | 1:1 | <1.0 × 10⁻⁹ |
| Comp. Ex. 2 | TBATFSA:LiTFSA | 1:1 | <1.0 × 10⁻⁹ |

### 2.3 Results and Discussion

As shown in Table 1, it can be seen that, in the case of lithium salt containing the quaternary ammonium cation and the lithium ion as the cation, the ionic conductivity in the solid state at room temperature is improved when the two sulfonylamide anion is contained as the anion (Examples 1 to 5) as compared with the case where only one type of sulfonylamide anion is contained as the anion (Comparative Examples 1 and 2). Among them, when a quaternary ammonium cation having a methyl group was used together with two types of sulfonylamide anions, the ionic conductivity is more easily improved.

It is presumed that the effect according to Examples 1 to 5 is due to the following mechanism. When a plurality of kinds of cations and anions constituting the lithium salt are used, the melting point of the lithium salt is lowered. In addition, when the lithium salt contains a plurality of kinds of sulfonylamide anions, lithium ions tend to be dissociable. Thus, it is considered that the ion conductivity is improved by the effect of lowering the melting point and the effect of improving the dissociation property of lithium ions. In addition, when the quaternary ammonium cation is one having a methyl group, it is considered that the steric hindrance becomes smaller and the lithium ion conduction path is easily secured as compared with a case where the quaternary ammonium cation has a butyl group. Therefore, it is considered that the ionic conductivity is further improved when those having a methyl group are used as the quaternary ammonium cation.

### 3. Supplement

In the above example, a lithium salt containing a TFSA anion as a first sulfonylamide anion and a FSA anion or a FTA anion as a second sulfonylamide anion in a predetermined molar ratio is exemplified, but the combination of the sulfonylamide anions is not limited thereto. By combining a plurality of kinds of sulfonylamide anions regardless of the type of sulfonylamide anion, an effect of lowering the melting point and an effect of improving the dis sociability of lithium ions can be obtained. The sulfonylamide anion may be a combination of two or a combination of three or more of them.

In addition, in the above examples, a lithium salt is exemplified as an alkali metal salt, but it is considered that the same effect is exhibited by the same mechanism when an alkali metal salt other than a lithium salt is used. When the alkali metal salt contains lithium ions, the alkali metal salt is suitable as a lithium ion conductor for a lithium ion secondary battery. In addition, when the alkali metal salt contains sodium ions, the alkali metal salt is suitable as a sodium ion conductor for a sodium ion secondary battery. In addition, when the alkali metal salt contains potassium ions, the alkali metal salt is suitable as a potassium ion conductor for a potassium ion secondary battery.

In the above examples, the ion conductivity of the alkali metal salt alone was evaluated, but in the alkali metal ion conductor of the present disclosure, the alkali metal salt and the other electrolyte may be combined. For example, an alkali metal salt and a sulfide solid electrolyte may be combined. In this case, in consideration of reactivity with respect to the sulfide solid electrolyte, the type of anion constituting the alkali metal salt may be selected. In particular, when a TFSA anion is contained as an anion, reactivity with a sulfide solid-state electrolyte can be suppressed. The preferred molar ratio of TFSA anion in the entire anion are as described in the embodiments. Note that, as for the cation (quaternary ammonium cation and alkali metal ion), since the reactivity with the sulfide solid electrolyte is low, the type and the like thereof are not particularly limited.

### 4. Conclusion

From the above results, it can be said that, according to the alkali metal ion conductor provided with the following configurations (1) and (2), it is possible to improve the filling ratio and the ion conductivity.
(1) The alkali metal ion conductor contains an alkali metal salt.
(2) The alkali metal salt comprises a quaternary ammonium cation, an alkali metal ion, a first sulfonylamide anion, and a second sulfonylamide anion different from the first sulfonylamide anion.

Further, in addition to the above configurations (1) and (2), the alkali metal ion conductor comprising the following configuration (3) is more easily improved in ion conductivity.
(3) The quaternary ammonium cation has a methyl group;

### REFERENCE SIGNS LIST

10 Positive electrode
11 Positive electrode active material layer
12 Cathode current collector
20 Electrolyte layer
30 Negative electrode
31 Negative electrode active material layer
32 Anode current collector
100 Secondary battery

1. An alkali metal ion conductor, comprising an alkali metal salt, wherein
the alkali metal salt comprises a quaternary ammonium cation, an alkali metal ion, a first sulfonylamide anion and a second sulfonylamide anion different from the first sulfonylamide anion.

2. The alkali metal ion conductor according to claim 1, wherein
the first sulfonylamide anion is a bistrifluoromethanesulfonylamide anion, and
the second sulfonylamide anion is at least one of a fluorosulfonylamide anion and a fluorosulfonyl (trifluoromethanesulfonyl) amide anion.

3. The alkali metal ion conductor according to claim 2, wherein
the molar ratio of the first sulfonylamide anion to the second sulfonylamide anion (the first sulfonylamide anion/the second sulfonylamide anion) is 1 or more.

4. The alkali metal ion conductor according to claim 1, wherein
the alkali metal ion conductor comprises the alkali metal salt and a sulfide solid electrolyte,
the first sulfonylamide anion is a bistrifluoromethanesulfonylamide anion,
the second sulfonylamide anion is at least one of a fluorosulfonylamide anion and a fluorosulfonyl (trifluoromethanesulfonyl) amide anion, and
the molar ratio of the first sulfonylamide anion to the second sulfonylamide anion (the first sulfonylamide anion/the second sulfonylamide anion) is 4 or more.

5. The alkali metal ion conductor according to claim 1, wherein
the quaternary ammonium cation has a methyl group.

6. The alkali metal ion conductor according to claim 1, wherein
the alkali metal ion is a lithium ion.

7. A secondary battery comprising a positive electrode, an electrolyte layer and a negative electrode, wherein
at least one of the positive electrode, the electrolyte layer and the negative electrode comprises an alkali metal ion conductor according to claim 1.
